(19) United States
(12) Patent Application Publication
(10) Pub. No.: US 2012/0065290 A1
(43) Pub. Date: Mar. 15, 2012

(54) Kind of High Oil-Absorbable Resin (HOAR) Comprising of Acrylic Polymers and its Preparation Methods and Uses

(76) Inventors: Yuee Fang, Hefei City (CN); Xiangyang He, Shanghai (CN); Gang Tang, Hefei City (CN)

(21) Appl. No.: 12/957,570

(22) Filed: Dec. 1, 2010

(30) Foreign Application Priority Data
Sep. 9, 2010 (CN) 201010277411.7

(51) Int. Cl. C08F 212/08; C08F 2/46

(52) U.S. Cl. 522/66; 526/329.1; 526/320; 522/182

(57) ABSTRACT

The present invention relates to a kind of high oil-absorbable resin (HOAR) comprising of acrylic polymers and its preparation methods and uses. High oil-absorbable resin as described includes following compositions by weight percentage: monomer of polymer flexible chain 50%-95%; monomer of polymer rigid chain 5%-50%; crosslinkers accounting for 0.2-5 wt % of total weight of above described monomers; and solvents weighing 1.5 to 4 folds of total weight of above described monomers. High oil absorption resin as described is prepared by free radical polymerization in solution at room temperature under γ-ray irradiation. The preparation process is simple with easily controlled reaction conditions, which can reduce energy consumption and provide safety and environmental protection, and thus it's suitable for industrial production. High oil-absorbable resin obtained has the advantages of high purity, complete hydrophobicity, wide range of applications, variety of absorbable oils, high-oil absorbable ratio, sound oil retaining performance and recyclable features etc., and it can be widely used in absorption of oil slicks, oil spills, factory lathe cooling emulsified oil and oil and organic substances in industrial and domestic sewage.

### FIELD OF THE INVENTION

The present invention relates to a kind of oil-absorbable material and its preparation methods and uses, and further relates to a kind of high oil-absorbable resin (HOAR) comprising of acrylic polymers and its preparation methods and uses in particular.

### BACKGROUND OF THE INVENTION

High oil-absorbable resin (HOAR) is a kind of moderately crosslinked polymers with three-dimensional network structures, and oil absorption force is driven by affinity between lipophilic groups in resins and molecules of oil. The process of oil absorption is a swelling and extending process of crosslinked three-dimensional network structures. This resin has advantages of high oil absorption capacity and good oil retaining performance, which can be used for handling a variety of oil pollution systems and also widely used in industry, agriculture, daily life and other fields as a kind of environmentally friendly material.

Oil absorbable materials can be divided into three types from the aspect of material evolution: the first type of oil absorbable materials makes use of oil absorption capacity of porous materials, such as cotton, sponge and clay, which are based on capillary force and belong to physical adsorption. This kind of oil absorbable materials has obvious shortcomings of low oil absorption ratio, poor oil-water selectivity and oil retaining performance. The second type of oil absorbable materials makes use of synthetic hydrophobic materials, such as fibers of polyethylene, polypropylene, polyethylene terephthalate, to prepare non-woven cloth and carpet with certain physical shape, which has improved oil absorption ratio and oil-water selectivity but still poor in oil retaining performance. The third type of oil absorbable materials is high oil-absorbable resins with three-dimensional network structures, which absorb oil via van der Waals forces between lipophilic groups inside the resins and oil molecules and later three-dimensional network structure retain oil molecules inside the swelling resins through van der Waals force. Van der Waals force is a weak interaction force, and thus the oil can be recovered by physical methods, and oil-absorbable resin can be reused which makes this type of oil absorbable material as a research hotspot.

The first oil-absorbable resin is developed by the U.S. Dow Chemical Company, which used styrene as monomer and divinylbenzene as crosslinker. In 1973, Japan Mitsui Petrochemical Company synthesized oil-absorbable polyacrylate resin with alkyl methacrylate as monomer. Later, United States, Japan and other countries had invested heavily into research on high-performance oil-absorbable resins. For example, in U.S. Pat. No. 5,641,847, Yoshiyuki Hozumi, et al. disclosed a kind of high oil-absorbable resin comprising of alkyl (meth)acrylate with alkyl chain of 10 to 16 carbon atoms as polymerizing monomer, ethylene glycol dimethacrylate as double bond monomer crosslinker and tested its oil absorption capacity on a variety of oils. Toru Inaok et al. disclosed in the U.S. Pat. No. 5,688,843 that a kind of high oil-absorbable resin prepared with alkyl (meth)acrylate and aryl (meth)acrylate as monomers and bifunctional monomer as crosslinkers had oil absorption rates of 25 g/g and 43.5 g/g on kerosene and toluene respectively with oil-retaining ratio ranged from 82.6% to 92.0%. Chinese Patent CN 1442438A disclosed a preparation method of high oil-absorbable resin with acrylate as monomer, ethylene glycol acrylate as crosslinker, gelatin and cellulose as dispersants, calcium phosphate as adjuvant dispersant, azo or organic peroxides as initiator, which synthesized high oil-absorbable resin in 0.3˜20 mm diameter by suspension polymerization achieving maximum oil absorption ratio of 37 times. Chinese Patent CN 1757658A disclosed preparation method of high oil-absorbable resin with styrene and long-chain olefins as polymerization monomer, which achieved maximum oil absorption ratio of 16.5 g/g and 36.7 g/g on toluene and chloroform respectively.

Meihua Zhou et al. synthesized high oil-absorbable resin via graft co-polymerization of 4-tert-butyl styrene and EPDM and strengthened the resins with PE (polyethylene), PP (polypropylene), PET (ethylene terephthalate) non-woven fabrics achieving oil absorption rate of 6.2˜24.4 g/g (High oil-absorptive composites based on graft co-polymerization of 4-tert-butyl styrene and EPDM, International Polymer Journal, 2001.50:1193-1120). Aili Cao et al. synthesized oil-absorbable resin with low crosslinking degree via emulsion polymerization methods achieving oil absorption rate of 27.86, 24.84 and 23.96 (g/g) on benzene, chloroform and tetrahydrofuran respectively (Synthesis and performance of acrylic high oil-absorbable resins, Polymer Materials and Engineering, 1999 (15), 38-40). Xiaoran Sun et al. synthesized high oil-absorbable and high-strength resins with styrene and a series of methyl acrylate via suspension polymerization achieving oil absorption rate of 25.20, 19.80 and 22.5 (g/g) on xylene, chloroform and kerosene respectively (Synthesis and performance of high oil-absorbable resin with acrylate-styrene copolymers, Plastics industry, 2003. 31 (7), 7-8).

Comprehensive analysis of these reports concludes that the used initiation method is decomposition of chemical initiator into free radicals to initiate polymerization. The majority of free radical polymerization adopts suspension polymerization with a minority of emulsion polymerization, and both polymerization systems require the addition of water-soluble macromolecular compounds and surface active agent respectively, combined with refractory controlled suspension condensation phenomena, which lead to problems in purity of synthetic resin, performance, application and process control difficulty etc.

### OBJECT OF THE INVENTION

The first technical problem to be solved in the present invention is to provide a kind of high oil-absorbable resin (HOAR) comprising of acrylic polymers with the advantages of high purity and complete hydrophobicity.

The second technical problem to be solved in the present invention is to provide a preparation method of high oil-absorbable resin (HOAR) comprising of acrylic polymers, and establish the optimal parameters for industrial production via experimental screening tests to provide the basis for industrial production. Wherein said polymerization adopts free radical polymerization in solution at room temperature under γ-ray radiation.

The third technical problem to be solved in the present invention is to provide an application for this high oil-absorbable resin (HOAR) comprising of acrylic polymers, e.g. it can be used to absorb a variety of oils and organic solvents, including oil slicks, oil spills, factory lathe cooling emulsified oil and oil and organic substances in industrial and domestic sewage.

### SUMMARY OF THE INVENTION

An acrylic polymers high oil-absorbable resin (HOAR) compositions is disclosed comprising by weight percentage: monome of Polimer flexible chain 50%-95%; monomer of Polimer rigid chain 5%-50%; and Bifunctional monomer crosslinkers accounting for 0.2-5 wt % of total weight of the monomer of polymer flexible chain and the monomer of polymer rigid chain; and solvents weighing 1.5 to 4 folds of total weight of the monomer of polymer flexible chain, the monomer of polymer rigid chain and the bifunctional monomer crosslinkers.

In one embodiment the monomer of polymer flexible chain can be selected from the group consisting of ethyl acrylate, propyl acrylate, butyl acrylate, amyl acrylate, hexyl acrylate, iso-octyl acrylate, 2-ethylhexyl methacrylate, dodecyl methacrylate; and wherein the monomer of polymer rigid chain can be selected from the group consisting of methyl methacrylate, ethyl methacrylate, propyl methacrylate, isopropyl methacrylate, butyl methacrylate, isobutyl methacrylate, sec-butyl methacrylate, tert-butyl methacrylate, cyclohexyl methacrylate, isobornyl methacrylate, vinyl acetate, acrylonitrile, tert-butyl styrene and styrene.

In another embodiment, the bifunctional monomer crosslinkers can be selected from the group consisting of ethylene glycol diacrylate, diethylene glycol diacrylate, propylene glycol diacrylate, ethylene glycol dimethacrylate, diethylene glycol dimethacrylate, propylene glycol dimethacrylate, polyethylene glycol diacrylate, phthalate diacrylate and divinyl benzene.

In one other embodiment, the solvent can be selected from the group consisting of n-heptane, iso-heptane, octane, cyclohexane, petroleum ether, benzene, toluene and xylene.

In another aspect of the invention, the preparation method of an acrylic polymers high oil-absorbable resin (HOAR) involving free radical polymerization in solution at room temperature under γ-ray radiation comprising: a. providing a monomer of polymer flexible chain, a monome of polymer rigid chain, a bifunctional monomer crosslinkers and solvents of into a reaction device comprising a stirring device, a reflux condenser, a temperature controller, a nitrogen ventilation, and an upper openable cover for thorough evenly mixing and oxide depletion by nitrogen ventilation; thereby generating a mixture; b. placing the mixture into a radiation source and controlling set radiation absorption dose rate and absorption dose in order to obtain a transparent acrylic polymer gel, and seal the a transparent acrylic polymer gel in dark environment under low temperature for future use; c. drying the gel to constant weight and recovering the solvents, thereby obtaining the desired acrylic polymers high oil-absorbable resin.

In one embodiment, the radiation sources are radionuclide Cobalt-60 or Cesium 137 radiation source and wherein the radiation sources initiate polymerization via high-energy electromagnetic wave y-ray by ionizing radiation. In another embodiment, the radiation absorption dose rate is 10 to 150 Gy/min and radiation absorption dose is 1.5 to 70 kGy. In another embodiment, the method to drying the gel to constant weight is selected from the group consisting of heating, vacuuming, far infrared, microwaving and refrigeration to recover the solvent. In yet another embodiment, the resin is effective in absorption of oil slicks, oil spills, factory lathe cooling emulsified oil and organic substances in industrial and domestic sewage.

### DETAILED DESCRIPTION OF THE INVENTION

High oil-absorbable resin (HOAR) comprising of acrylic polymers as described includes following compositions by weight percentage:

| | |
|---|---|
| monomer of polimer flexible | 50%-95% |
| chain | |
| monomer of polimer rigid | 5%-50% |
| chain | |

Crosslinkers accounting for 0.2-5 wt % of total weight of above described monomers; and solvents weighing 1.5 to 4 folds of total weight of above described monomers.

monomer of polimer flexible chain as described can be selected from acrylates composing of 2 to 8 carbon atoms and methacrylates composing of 8 to 12 carbon atoms, for example, any or several of ethyl acrylate, propyl acrylate, butyl acrylate, amyl acrylate, hexyl acrylate, iso-octyl acrylate, 2-ethylhexyl methacrylate, dodecyl methacrylate.

monomer of polimer rigid chain as described can be selected from methacrylates composing of 1 to 6 carbon atoms with glass transition temperature over 0□ which include monomers containing reactive double bond with suitable reactivity ratio to above described monomer of polimer flexible chain, for example, any or several of ethyl methacrylate, propyl methacrylate, isopropyl methacrylate, butyl methacrylate, isobutyl methacrylate, sec-butyl methacrylate, tert-butyl methacrylate, cyclohexyl methacrylate, isobornyl methacrylate, vinyl acetate, acrylonitrile, tert-butyl styrene and styrene.

Bifunctional monomer crosslinkers as described can be selected from any of ethylene glycol diacrylate, diethylene glycol diacrylate, propylene glycol diacrylate, ethylene glycol dimethacrylate, diethylene glycol dimethacrylate, propylene glycol dimethacrylate, polyethylene glycol diacrylate, phthalate diacrylate and divinyl benzene.

Solvent as described are non-active alkanes, aromatics or mixtures of them, which can be selected from n-heptane, iso-heptane, octane, cyclohexane, petroleum ether, benzene, toluene and xylene etc.

High oil-absorbable resin (HOAR) comprising of acrylic polymers as described are prepared by free radical polymerization in solution at room temperature under y-ray irradiation, including the following steps:
Add the ingredients as defined claim 1 into a reaction device with stirring device, reflux condenser, temperature controller, nitrogen ventilation, and upper openable cover for thorough evenly mixing and oxide depletion by nitrogen ventilation;
Place above mixture into the radiation source and control set radiation absorption dose rate and absorption dose to obtain transparent acrylic polymer gel, and store the obtained polymers sealed in dark under low temperature for future use;
Dry above gel to constant weight and recover solvents, and thus High Oil-Absorbable Resin (HOAR) comprising of acrylic polymers as defined are obtained.

In above preparation methods, wherein said radiation sources are radionuclide Cobalt-60 or Cesium 137 radiation source and wherein said radiation sources initiate polymerization via high-energy electromagnetic wave y-ray by ionizing radiation.

Wherein said radiation absorption dose rate is 10 to 150 Gy/min and radiation absorption dose is 1.5 to 70 kGy.

Wherein said dried gel polymers are obtained by heating, vacuum, far infrared, microwave or refrigeration removal of solvents and solvent recovery.

Application and technical parameters, measurement and calculation methods of high oil-absorbable resin (HOAR) comprising of acrylic polymers in the invention are described as follows:

1. Oil absorption operation steps:

1.1 Add a certain amount of high oil-absorbable resins which have dried to constant weight into subject oil or organic solvents and wait until oil-absorbable resins showed swelling and transparent gelatinous state, which indicates an oil saturation state.

1.2 Adopt filter (20-60 mesh) drop leaching method to separate absorbing gel and organic solvents, oil and water.

1.3 Weigh oil-absorbable gel (accurate to four decimal places) and calculate oil absorption rate according to formula.

2. Technical parameters, measurement and calculation methods

2.1 Polymerization conversion ratio

Weigh a certain amount of resin sample (accurate to four decimal places), calculate theoretical masses of monomer and crosslinkers wherein total weight of them as W₀, and dried constant weight as W₁, and then calculate polymerization conversion ratio according to the following formula.

$$Polymerization conversation ratio ( \% ) = \frac{{W}_{1}}{{W}_{0}} \times 100 \%$$

2.2 Gel fraction

Weigh a certain amount of dry samples (accurate to four decimal places) as W₀₂, use Soxhlet extraction device with tetrahydrofuran extraction for 24 hours, dry the sample to a constant weight as W₂, and then calculate gel fraction according to the following formula.

$$Gel fraction ( \% ) = \frac{{W}_{2}}{{W}_{02}} \times 100 \%$$

2.3 Oil absorption rate

Weigh a certain amount of resin sample (accurate to four decimal places) as W₀₃, place it into a glass container, add set amount of test oil, soak at room temperature, periodically measure the mass of resins until a constant weight W₃, and then calculate oil absorption rate according to the following formula.

$$Oil absorption rate ( g \text{/} g ) = \frac{{W}_{3} - {W}_{03}}{{W}_{03}}$$

2.4 Mechanical oil retaining ratio

Weigh a certain amount of oil-saturate resin (accurate to four decimal places) as W₀₄, place it into a centrifuge tube and centrifuge at 3000 rpm for 15 minutes, filter and weigh gel mass (accurate to four decimal places) as W₄, and then calculate mechanical oil retaining ratio according to the following formula.

$$Mechanical oil reataining ratio ( \% ) = \frac{{W}_{4}}{{W}_{04}} \times 100 \%$$

2.5 Thermal decomposition temperature

Thermal stability analysis, weigh 10 mg dry resin (accurate to four decimal places) for thermal stability analysis under the temperatures from room temperature to 700□ with nitrogen atmosphere.

2.6 Density of resin

Add a precise amount of distilled water for scale calibration of a graduated cylinder with special precision scale and stopper. Weigh a certain amount of resin sample W₀₅ (accurate to four decimal places), prepare a stainless steel bar with certain volume (V1), add the sample into the graduated cylinder with the stainless steel bar as well as precisely scaled 100 ml distilled water, eliminate the bubbles, and place it still for 30 minutes. Then observe and record the volume of water at room temperature in the graduated cylinder as V2.

Density (mg/ml)=W₀₅V2−V1−100

High Oil-Absorbable Resin (HOAR) comprising of acrylic polymers in the invention features as follows: polymerization conversion ratio %≧99.50, gel fraction %≧60, resin density (mg/ml) of about 0.9, resin thermal decomposition temperature of 221.67˜374.92□. High Oil-Absorbable Resin (HOAR) in the present invention has high purity, wide application range and variety of absorbing oil (including aromatics, chlorinated hydrocarbons, ketones, acetic acid esters, hydrocarbons and organic solvents) with oil absorption rate of about 10˜50 g/g and mechanical oil retaining ratio %≧90 (see in Table 1).

TABLE 1
Relevant Parameters of High Oil-Absorbable
Resin in the Invention on Different Oils

| | Saturated oil | Mechanical oil |
|---|---|---|
| | absorption | retaining |
| Oil product names | rate(g/g) | ratio (%) |
| Benzene | 28.22 | 90.66 |
| Toluene | 28.56 | 94.48 |
| Xylene | 28.14 | 96.79 |
| Acetone | 0.71 | 81.15 |
| Butanone | 15.13 | 94.21 |
| 2-methyl | 19.77 | 96.83 |
| pentanone | | |
| Dichloromethane | 25.04 | 94.46 |
| Chloroform | 50.48 | 98.34 |
| Anhydrous ether | 14.43 | 93.16 |
| THF | 29.36 | 97.10 |
| Ethyl acetate | 14.66 | 92.79 |
| Butyl acetate | 19.92 | 96.97 |
| Isoamyl acetate | 19.98 | 96.99 |
| n-Heptane | 16.32 | 92.84 |
| Cyclohexane | 19.67 | 91.60 |
| Gasoline 120 | 12.85 | 95.63 |
| Petroleum ether | 18.13 | 87.10 |
| Kerosene | 18.74 | 93.58 |
| Diesel | 24.09 | 92.67 |
| Emulsified | 10.54 | 90.24 |
| Kerosene | | |
| Emulsified diesel | 14.92 | 94.45 |
| Kerosene oil slick | 22.77 | 96.43 |
| Diesel oil slick | 21.47 | 93.37 |

### Beneficial Outcomes:

Without addition of water-soluble material in the formulations, high oil-absorbable resin (HOAR) comprising of acrylic polymers in the invention thus has the advantages of high purity, complete hydrophobicity, wide range of applications, variety of absorbable oils, high-oil absorbable ratio, sound oil retaining performance and recyclable features etc. In addition, the used initiation method in the invention is to initiate polymerization via high-energy electromagnetic wave γ-ray by ionizing radiation. The preparation process is under room temperature in one step, which is simple reaction process with easily controlled reaction conditions, and thus it can reduce energy consumption and provide safety and environmental protection, and thus it's suitable for industrial production.

### EMBODIMENT

The following examples are put forth so as to provide a detailed description of technical protocol of but not limit of this invention.

### Example 1

### 1. Formulation

### In Weight Percentage

| Composition | Percentage | |
|---|---|---|
| N-butyl acrylate | 90 | 100 |
| Tert-butyl styrene | 10 | |
| Divinyl benzene | | 0.55 |
| Heptane | | 220 |

### 2. Preparation

According to the above formulation, add ingredients into a radiation device with stirring device, reflux condenser, temperature controller, nitrogen ventilation, and upper openable cover; disperse under 40 KHz ultrasonic conditions for 20 minutes under ventilation of high-purity nitrogen for 20 minutes and then seal and place it into ⁶⁰Co radiation source with absorption dose rate of 75.5014 Gy/min, and take it out when the radiation absorption dose reaches 7.210 kGy to obtain a transparent acrylate polymer gel and store it sealed at low temperature away from light for future use.

Place above transparent acrylate polymer gel into a designed-shape device and dry it to a constant weight (and recover solvents) at about 100□, and the product is High Oil-Absorbable Resin (HOAR) comprising of acrylic polymers in the invention. After testing, saturated oil absorption rate of this resin on toluene and chloroform were 28.56 and 43.0 (g/g) respectively and mechanical oil retaining ratio (%) were 94.48 and 98.34.

### Example 2

### 1. Formulation

### In Weight Percentage

| Composition | Percentage | |
|---|---|---|
| Dodecyl methacrylate | 87 | 100 |
| Styrene | 13 | |
| Glycol diacrylate | | 0.75 |
| Toluene | | 180 |

### 2. Preparation

According to the above formulation, add ingredients into a radiation device with stirring device, reflux condenser, temperature controller, nitrogen ventilation, and upper openable cover; stir the ingredients at 80 rpm for 20 minutes under ventilation of high-purity nitrogen for 25 minutes; and then seal and place it into ⁶⁰Co radiation source with absorption dose rate of 100.1975 Gy/min, and take it out when the radiation absorption dose reaches 2.988 kGy to obtain a transparent acrylate polymer gel and store it sealed at low temperature away from light for future use.

Place above transparent acrylate polymer gel into a designed-shape device and dry it to a constant weight (and recover solvents), and the product is High Oil-Absorbable Resin (HOAR) comprising of acrylic polymers in the invention. After testing, saturated oil absorption rate of this resin on butanone and butyl acetate were 15.13 and 19.98 (g/g) respectively and mechanical oil retaining ratio (%) were 94.21 and 96.99.

### Example 3

### 1. Formulation

### In Weight Percentage

| Composition | Percentage | |
|---|---|---|
| Dodecyl methacrylate | 85 | 100 |
| Vinyl acetate | 15 | |

| | |
|---|---|
| Ethylene glycol | 0.30 |
| dimethacrylate | |
| Cyclohexane | 150 |

### 2. Preparation

According to the above formulation, add ingredients into a radiation device with stirring device, reflux condenser, temperature controller, nitrogen ventilation, and upper openable cover; stir the ingredients at 80 rpm for 15 minutes under ventilation of high-purity nitrogen for 20 minutes; and then seal and place it into ⁶⁰Co radiation source with absorption dose rate of 20.2306 Gy/min, and take it out when the radiation absorption dose reaches 14.570 kGy to obtain a transparent acrylate polymer gel and store it sealed at low temperature away from light for future use.

Place above transparent acrylate polymer gel into a designed-shape device and dry it to a constant weight (and recover solvents) at about 80□, and the product is High Oil-Absorbable Resin (HOAR) comprising of acrylic polymers in the invention.

After testing, saturated oil absorption rate of this resin on kerosene and diesel were 18.74 and 24.09 (g/g) respectively and mechanical oil retaining ratio (%) were 93.58 and 92.67.

### Example 4

### 1. Formulation

### In Weight Percentage

| Composition | Percentage | |
|---|---|---|
| Ethylhexyl acrylate | 85 | 100 |
| Acrylonitrile | 15 | |

| | |
|---|---|
| Divinylbenzene | 0.6 |
| Benzene | 180 |

### 2. Preparation

According to the above formulation, add ingredients into a radiation device with stirring device, reflux condenser, temperature controller, nitrogen ventilation, and upper openable cover; stir the ingredients at 80 rpm for 15 minutes under ventilation of high-purity nitrogen for 15 minutes; and then seal and place it into ⁶⁰Co radiation source with absorption dose rate of 51.3260 Gy/min, and take it out when the radiation absorption dose reaches 9.867 kGy to obtain a transparent acrylate polymer gel and store it sealed at low temperature away from light for future use.

Place above transparent acrylate polymer gel into a designed-shape device and dry it to a constant weight (and recover solvents) at over 80□, and the product is High Oil-Absorbable Resin (HOAR) comprising of acrylic polymers in the invention. After testing, saturated oil absorption rate of this resin on emulsified kerosene, emulsified diesel, kerosene oil slick and diesel oil slick were 10.5, 15.0, 22.8 and 21.5 (g/g) respectively and mechanical oil retaining ratio (%) were 90.24, 94.45, 96.43 and 93.37 respectively.

1. An acrylic polymers high oil-absorbable resin (HOAR) compositions comprising by weight percentage:
Monomer of polymer flexible chain 50%-95%;
Monomer of polymer rigid chain 5%-50%; and
Bifunctional monomer crosslinkers accounting for 0.2-5 wt % of total weight of said monomer of polymer flexible chain and said monomer of polymer rigid chain; and solvents weighing 1.5 to 4 folds of total weight of said monomer of polymer flexible chain, said monomer of polymer rigid chain and said bifunctional monomer crosslinkers.

2. The acrylic polymers high oil-absorbable resin (HOAR) of claim 1 wherein said monomer of polymer flexible chain can be selected from the group consisting of ethyl acrylate, propyl acrylate, butyl acrylate, amyl acrylate, hexyl acrylate, iso-octyl acrylate, 2-ethylhexyl methacrylate, dodecyl methacrylate; and wherein said monomer of polymer rigid chain can be selected from the group consisting of methyl methacrylate, ethyl methacrylate, propyl methacrylate, isopropyl methacrylate, methacrylate, isobutyl methacrylate, sec-butyl methacrylate, tert-butyl methacrylate, cyclohexyl methacrylate, isobornyl methacrylate, vinyl acetate, acrylonitrile, tert-butyl styrene and styrene.

3. The acrylic polymers high oil-absorbable resin (HOAR) of claim 1 wherein said bifunctional monomer crosslinkers can be selected from the group consisting of ethylene diacrylate, diethylene diacrylate, propylene glycol diacrylate, ethylene glycol dimethacrylate, diethylene glycol dimethacrylate, propylene glycol dimethacrylate, polyethylene glycol diacrylate, phthalate diacrylate and divinyl benzene.

4. The acrylic polymers high oil-absorbable resin (HOAR) of claim 1 wherein said solvent can be selected from the group consisting of n-heptane, iso-heptane, octane, cyclohexane, petroleum ether, benzene, toluene and xylene.

5. The preparation method of an acrylic polymers high oil-absorbable resin (HOAR) of claim 1 involving free radical polymerization solution at room temperature under γ-ray irradiation comprising:
a. providing said monomer of polymer flexible chain, said monomer of polymer rigid chain, said bifunctional monomer crosslinkers and said solvents of claim 1 into a reaction device comprising a stirring device, a reflux condenser, a temperature controller, a nitrogen ventilation, and an upper openable cover for thorough evenly mixing and oxide depletion by nitrogen ventilation; thereby generating a mixture;
b. placing said mixture into a radiation source and controlling set radiation absorption dose rate and absorption dose in order to obtain a transparent acrylic polymer gel, and seal said a transparent acrylic polymer gel in dark environment under low temperature for future use;
c. drying said gel to constant weight and recovering said solvents, thereby obtaining said composition of claim 1.

6. The preparation method of claim 5 wherein said radiation sources are radionuclide Cobalt-60 or Cesium 137 radiation source and wherein said radiation sources initiate polymerization via high-energy electromagnetic wave γ-ray by ionizing radiation.

7. The preparation method of claim 5 wherein said radiation absorption dose rate is 10 to 150 Gy/min and radiation absorption dose is 1.5 to 70 kGy.

8. The preparation method of claim 5 wherein said drying said gel to constant weight is selected from the group consisting of heating, vacuuming, far infrared, microwaving and refrigeration.

9. The acrylic polymers high oil-absorbable resin (HOAR) of claim 1 wherein said resin is effective in absorption of oil slicks, oil spills, factory lathe cooling emulsified oil and organic substances in industrial and domestic sewage.
